(19) United States
(12) Patent Application Publication
(10) Pub. No.: US 2019/0007770 A1
(43) Pub. Date: Jan. 3, 2019

(54) SOUND VOLUME CONTROL DEVICE, SOUND VOLUME CONTROL METHOD AND PROGRAM

(71) Applicant: PIONEER CORPORATION, Tokyo (JP)

(72) Inventor: Akihiro ISEKI, Saitama (JP)

(21) Appl. No.: 16/062,323

(22) PCT Filed: Dec. 17, 2015
(86) PCT No.: PCT/JP2015/085414

§ 371 Date: Jun. 14, 2018

(51) Int. Cl. H04R 3/04; H04R 1/22

(52) U.S. Cl. CPC H04R 3/04; H04R 2499/13; H04R 2430/01; H04R 1/227

(57) ABSTRACT

The sound volume control device is connected to the output unit arranged between the front seat and the rear seat of the movable body. The sound volume control device estimates the frequency of the peak, common to the frequency characteristics at the front seat and the rear seat, of the sound outputted by the output unit, and corrects the level of the sound outputted by the output unit at the frequency of the peak. Thus, the sound signal is controlled to correct the peak commonly occurring on the frequency characteristics at the front and rear listening positions.

### TECHNICAL FIELD

The present invention relates to a technique of adjusting sound that a listener listens in a vehicle interior space.

### BACKGROUND TECHNIQUE

There are proposed methods of adjusting sound pressure levels of reproduced sound in an acoustic space such as a vehicle interior. For example, Patent Reference-1 discloses a technique of collecting sounds emitted from a plurality of speakers by a plurality of microphones to measure a sound pressure distribution in an acoustic space, and determining filter coefficients. In this document, structure in the vehicle interior is not taken into consideration, and the frequency bands in which equalizing is applied are determined by simulation or calculation to extract peaks and dips based on the frequency characteristic.

### PRIOR ART REFERENCE

### Patent Reference

Patent Reference-1: Japanese Patent Application Laid-Open under No. 2009-159385

### SUMMARY OF THE INVENTION

### Problem to be Solved by the Invention

When sound signals are reproduced in a vehicle interior, reflection by doors, windows and seats of the vehicle interior generates peaks and dips in a frequency characteristic of the sound signal listened at each seat. Normally, since there are front seats and rear seats in the vehicle interior, it is desired to correct peaks and dips in the frequency characteristic at both seats.

For example, it is supposed that the sound from rear speakers is too large in a certain frequency band for a person at the rear seat. In this case, if the sound in the frequency band is decreased, it becomes comfortable for the person at the rear seat, but the sound in the frequency band becomes inaudible for a person at the front seat. In this case, Patent Reference-1 needs to perform large-scale calculation every time.

The above is an example of the problem to be solved by the present invention. It is an object of the present invention to provide a sound volume control device capable of correcting peaks in frequency characteristics at two seats, i.e., front and rear seats in a vehicle interior at the same time, without requiring complicated calculation.

### Means for Solving the Problem

An invention described in claims is a sound volume control device connected to an output unit arranged between a front seat and a rear seat of a movable body, comprising: an estimating unit configured to estimate a frequency of a peak, common to frequency characteristics at the front seat and the rear seat, of sound outputted by the output unit; and a correcting unit configured to correct a level of the sound outputted by the output unit at the frequency of the peak.

Another invention described in claims is a sound volume control method executed by a sound volume control device connected to an output unit arranged between a front seat and a rear seat of a movable body, comprising: an estimating process configured to estimate a frequency of a peak, common to frequency characteristics at the front seat and the rear seat, of sound outputted by the output unit; and a correcting process configured to correct a level of the sound outputted by the output unit at the frequency of the peak.

Still another invention described in claims is a program executed by a sound volume control device including a computer and connected to an output unit arranged between a front seat and a rear seat of a movable body, the program causing the computer to function as: an estimating unit configured to estimate a frequency of a peak, common to frequency characteristics at the front seat and the rear seat, of sound outputted by the output unit; and a correcting unit configured to correct a level of the sound outputted by the output unit at the frequency of the peak.

### BRIEF DESCRIPTION OF THE DRAWINGS

FIG. 1 is a plan view illustrating an example of a vehicle interior configuration of a general sedan-type vehicle.

FIG. 2 illustrates a schematic configuration of a sound volume control device according to an embodiment.

FIGS. 3A and 3B are diagrams explaining a reason why there exists a frequency band in which sound pressure becomes high at front and rear seats.

FIG. 4 is a diagram explaining a method of determining a controlled band based on a vehicle configuration.

FIGS. 5A and 5B are graphs illustrating an example of a frequency band in which sound pressure becomes high at the front and rear seats.

FIG. 6 illustrates graphs illustrating effects of a conventional technique and a technique of the embodiment.

FIG. 7 illustrates a configuration of a sound volume control device which reproduces sound from left and right speakers.

FIGS. 8A to 8C illustrates frequency characteristics in a case where a stereo signal is inputted to the left and right speakers.

FIGS. 9A to 9C illustrates frequency characteristics in a case where a monaural signal is inputted to the left and right speakers.

FIG. 10 is a flowchart of attenuation processing by the sound volume control device of the embodiment.

FIG. 11 illustrates an example of a vehicle interior environment in a modified embodiment.

### DETAILED DESCRIPTION OF THE PREFERRED EMBODIMENTS

According to one aspect of the present invention, there is provided a sound volume control device connected to an output unit arranged between a front seat and a rear seat of a movable body, comprising: an estimating unit configured to estimate a frequency of a peak, common to frequency characteristics at the front seat and the rear seat, of sound outputted by the output unit; and a correcting unit configured to correct a level of the sound outputted by the output unit at the frequency of the peak.

The above sound volume control device is connected to the output unit arranged between the front seat and the rear seat of the movable body. The sound volume control device estimates the frequency of the peak, common to the frequency characteristics at the front seat and the rear seat, of the sound outputted by the output unit, and corrects the level of the sound outputted by the output unit at the frequency of the peak. Thus, the sound signal is controlled to correct the peak commonly occurring on the frequency characteristics at the front and rear listening positions.

In one mode of the above sound volume control device, the peak is generated by synthesizing a direct sound and a reflected sound, the direct sound being a sound outputted by the output unit and reaching a listening position without being reflected in the movable body, the reflected sound being a sound outputted by the output unit and reaching the listening position after being reflected by a predetermined position in the movable body. In this mode, the peak occurring by synthesizing the direct sound and the reflected sound is corrected.

In another mode of the above sound volume control device, the estimating unit estimates the frequency of the peak based on vehicle information of the movable body. In this mode, the frequency of the peak is determined based on the vehicle information of the movable body.

Still another mode of the above sound volume control device further comprises an input device configured to input the vehicle information of the movable body, and the estimating unit estimates the frequency of the peak based on the vehicle information inputted. In this mode, the frequency of the peak is estimated based on the vehicle information inputted by a user. In a preferred example, the estimating unit estimates the frequency of the peak by an equation based on a vehicle width of the movable body.

In still another mode of the above sound volume control device, the output unit is arranged at a position close to one of the front seat and the rear seat. Since the output unit is arranged close to one of the front seat and the rear seat, the common peak occurs on the frequency characteristics at the front seat and the rear seat.

In still another mode of the above sound volume control device, one of the front seat and the rear seat includes a screening object, and the screening object partly screens the sound outputted by the output unit and reaching a listening position in the one of the front seat and the rear seat that includes the screening object. Due to the screening by the screening object in the front seat or the rear seat, the peak common to the frequency characteristics at the front seat and the rear seat occurs.

According to another aspect of the present invention, there is provided a sound volume control method executed by a sound volume control device connected to an output unit arranged between a front seat and a rear seat of a movable body, comprising: an estimating process configured to estimate a frequency of a peak, common to frequency characteristics at the front seat and the rear seat, of sound outputted by the output unit; and a correcting process configured to correct a level of the sound outputted by the output unit at the frequency of the peak. By this method, the sound signal is controlled to correct the peak commonly occurring on the frequency characteristics at the front and rear listening positions.

According to still another aspect of the present invention, there is provided a program executed by a sound volume control device including a computer and connected to an output unit arranged between a front seat and a rear seat of a movable body, the program causing the computer to function as: an estimating unit configured to estimate a frequency of a peak, common to frequency characteristics at the front seat and the rear seat, of sound outputted by the output unit; and a correcting unit configured to correct a level of the sound outputted by the output unit at the frequency of the peak. By executing this program by the computer, the sound signal is controlled to correct the peak commonly occurring on the frequency characteristics at the front and rear listening positions. This program may be handled in a manner stored in a storage medium.

### EMBODIMENTS

[Basic Principle]

First, a basic principle of a sound volume control according to the embodiments will be described. While the acoustic characteristic in a vehicle interior depends on an interior configuration of the vehicle, general vehicles have similar interior configurations and speaker positions. In a general sedan-type vehicle, a driver's seat and an assistant driver's seat are arranged symmetrically as the front seats, and two seats are arranged symmetrically as the rear seats. Also, a front speaker and a rear speaker are mounted on left and right doors, respectively. In this way, since the interior configurations and the speaker positions are similar in general vehicles, the ways that the sound reaches from the left and right speakers to the front seats and the rear seats are basically similar in any vehicle.

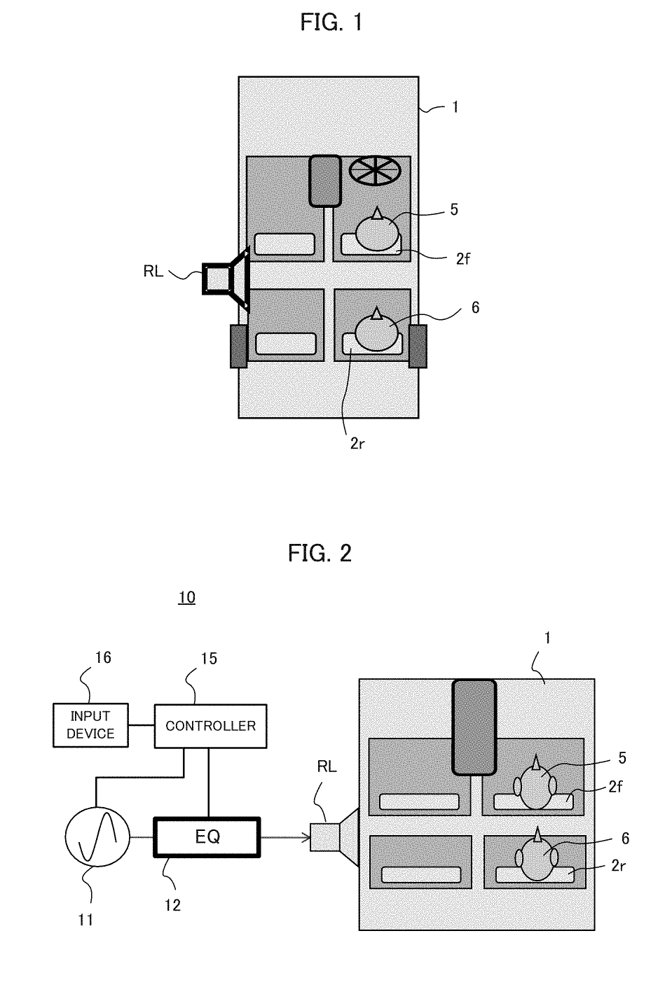

FIG. 1 shows an example of an interior configuration of a general sedan-type vehicle. Supposing that the vehicle 1 is a right-hand drive vehicle, a driver 5 sits on a front (driver's) seat 2f and a passenger 6 sits on the rear seat 2r. A left rear speaker RL is mounted on the left-side door of the rear seat. While a right rear speaker RR is mounted on the right-side door of the rear seat, the illustration thereof is omitted in FIG. 1.

In the vehicle interior configuration and the speaker position like this, when two seats of the vehicle, i.e., the front seat 2f and the rear seat 2r are set as listening positions and the sound reproduced by a single speaker is listened at those two seats, there is a frequency band (hereinafter simply referred to as “band”) at which both of the frequency characteristics of the sound listened at those two seats have a peak in common. This is because the sound directly reaching from the rear speaker provided on the door to the listening position (hereinafter referred to as “direct sound”) and the sound reproduced by the rear speaker and reaching the listening position after being reflected by the door on the opposite side (hereinafter referred to as “reflected sound”) are synthesized with (i.e., added to) each other at the listening positions of the two seats.

Here, “listening position” is a position of the head of the passenger sitting on the front or rear seat, and “sound pressure at the listening position” is a sound pressure at the center position of the head of the passenger or a sum of the sound pressures at left and right ears of the passenger. Also, in the following description, “two seats” means the front and rear seats, specifically the combination of the front and rear seats on the right side of the vehicle interior or the front and rear seats on the left side of the vehicle interior.

As described above, the sound volume control device according to the embodiments determines, as the controlled band, the band (hereinafter referred to as “common peak frequency band”) at which both of the sound signals collected at the two seats of the vehicle has the peak, and performs attenuation control of the sound signals reproduced by the rear speaker at the control band. Thus, the frequency characteristics at the two seats are corrected at the same time.

### Embodiments

(Basic Configuration)

FIG. 2 shows a schematic configuration of the sound volume control device 10 according to the embodiments. In the embodiments, when the sound is outputted by at least one of the speakers to the two seats of the vehicle, the attenuation control is performed at a certain control band of the sound signals supplied to the speakers. This attenuation control includes equalizer processing, gain control processing and attenuation processing.

Specifically, as shown in the example of FIG. 2, the sound signal outputted by a sound source 11 is supplied to an equalizer 12. The equalizer 12 performs the control of attenuating the level of the sound signal at the controlled band, and supplies the attenuated sound signal to the rear speaker RL mounted on the vehicle 1. The rear speaker RL reproduces the supplied sound signal to output sound.

A controller 15 is connected to the equalizer 12, and an input device 16 is connected to the controller 15. The input device 16 is used when a user inputs vehicle information such as a vehicle type name, as described later. The controller 15 supplies a signal indicating the controlled band to the equalizer 12 based on the vehicle information inputted to the input device 16. Specifically, the controller 15 includes a vehicle information database (DB) associating the vehicle information such as a vehicle type name with a vehicle width. When the user inputs the vehicle type name to the input device 16, the controller 15 refers to the vehicle information DB to obtain the vehicle width (w) of the vehicle type, and determines the controlled band using the vehicle width as described later.

Thus, the sound volume control device according to the embodiments can correct the peak appearing in common in the frequency characteristics of the sound listened at the two seats, without the need of complicated calculation. While the sound is outputted only by the left-side rear RL of the vehicle in the above example, the present invention is applicable to the case where the sound is outputted only by the right-side rear speaker RR.

(Determination of Controlled Band)

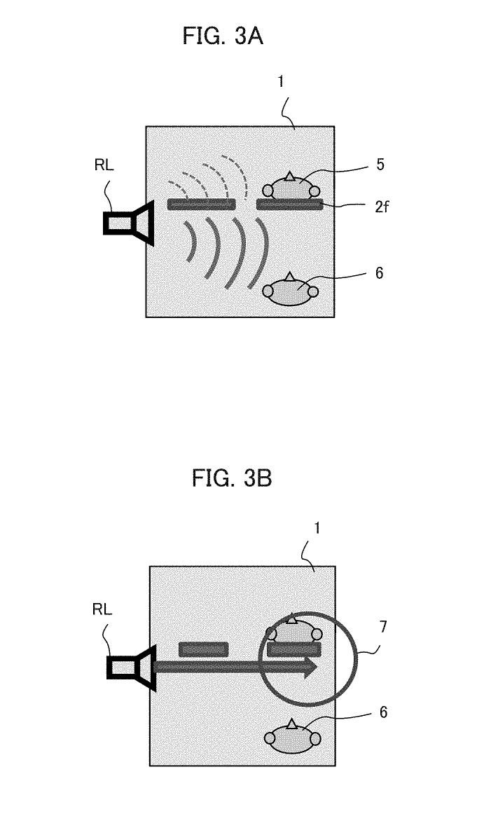

First, the description will be given of the reason why there exists a common peak band in which the sound pressures of the sound signals listened at two seats of the vehicle becomes high at the same time. FIGS. 3A and 3B schematically illustrate the situation in the vehicle interior wherein the passengers sit on the two seats. As shown in FIG. 3A, the sound outputted by the rear speaker PL is primarily easy to reach only the rear seat (hereinafter referred to as “Phenomenon-1”). This is because the front seats, particularly the backrests of the front seats form the structure of screening the front seat space and the rear seat space from each other. Therefore, the sound outputted by the rear speaker RL is partly blocked by the backrest and is difficult to reach the front seats.

On the other hand, as shown in FIG. 3B, the front seat is nearer to the front direction, i.e., the direction in which the sound outputted by the rear speaker RL travels, than the rear seat (see. the circle 7 in FIG. 3B). Therefore, the direct sound and the reflected sound outputted from the rear speaker RL overlap, i.e., interfere, more easily at the front seat than at the rear seat (hereinafter referred to as “Phenomenon-2”). Due to the Phenomenon-1 and Phenomenon-2 described above, there occurs a common peak band in which the sound pressures of the sound signals at the two seats becomes high at the same time.

The degree of the above Phenomenon-2 depends on the position of the rear speaker RL in the front-rear direction. However, in a general vehicle, the rear speaker is arranged near the front seat, specifically nearer to the front seat than the center position of the front seat and the rear seat as shown in FIG. 3B, the above Phenomenon-2 occurs.

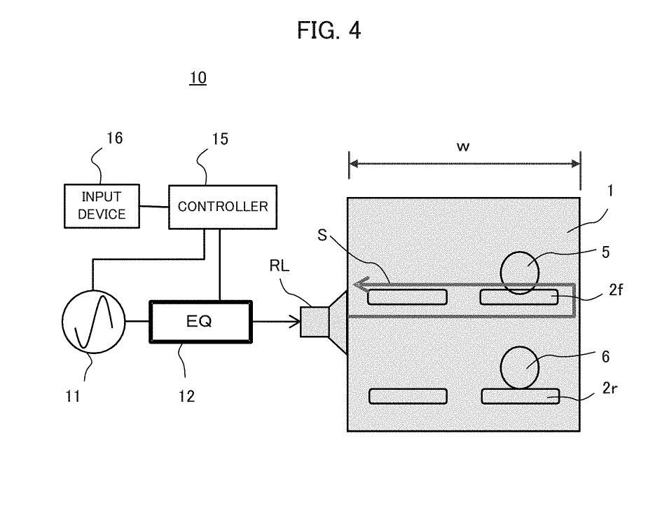

Next, the description will be given of the method of determining the frequency of the common peak band (hereinafter referred to as “common peak frequency”). FIG. 4 illustrates an example of a vehicle interior configuration. The sound outputted from the rear speaker RL reaches the front seat 2f and the rear seat 2r as the direct sound as shown by the route S, and also reaches the front seat 2f and the rear seat 2r as the reflected sound after being reflected by the right-side door. Since the direct sound and the reflected sound reach the front seat 2f and the rear seat 2r serving as the listening position, the direct sound and the reflected sound are added to each other in the frequency band in which the direct sound and the reflected sound are in phase with each other, thereby causing the peak in the frequency characteristic. The frequency of the peak is the common peak frequency.

The common peak frequency can be determined based on the size of the vehicle. As shown in FIG. 4, assuming that the vehicle width is “w”, the common peak frequency is obtained as follows:

Fpeak[Hz]=C[m/s]/D[m] (1)

Here, “C” is a sound velocity (340 ms), and “D (=2 w) ” is a distance that the sound outputted by the rear speaker RL is reflected by the opposite-side door and returns to the position of the rear speaker RL, i.e., the distance of the route S shown in FIG. 4.

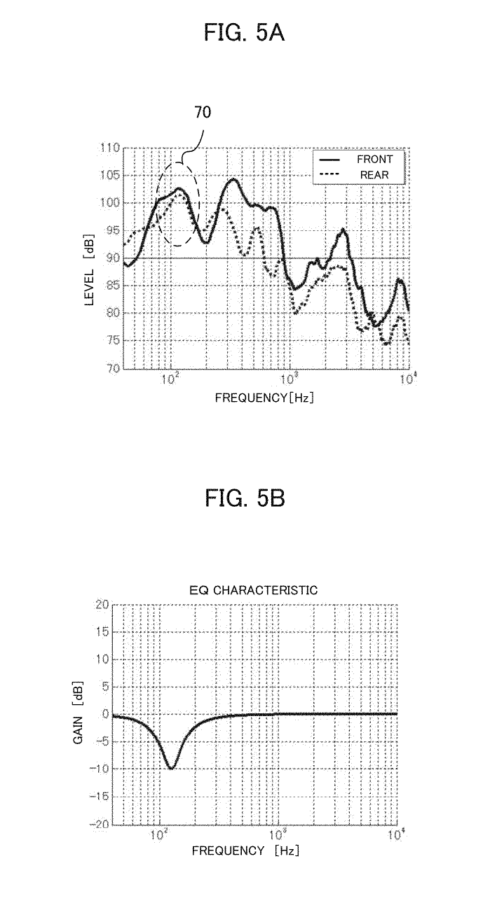

Now, assuming that w=1.4 m as a width of a general vehicle, the common peak frequency Fpeak is calculated as approximately 121 Hz by the equation (1). FIG. 5A shows the frequency characteristics at the front (driver's) seat and the rear seat in this case. As shown by the ellipse 70, there occurs a peak common to the front seat and the rear seat in the frequency band around 125 Hz.

(Attenuation Control)

When the common peak frequency is determined in this way, the controller 15 controls the equalizer 12 to attenuate the signal level at the common peak frequency. Specifically, the controller 15 sets, to the equalizer 12, the characteristic to attenuate the signal level around the common peak frequency as shown in FIG. 5B. Thus, it becomes possible to correct the peaks simultaneously occurring at the two seats, i.e., the front and rear seats, due to the vehicle interior configuration.

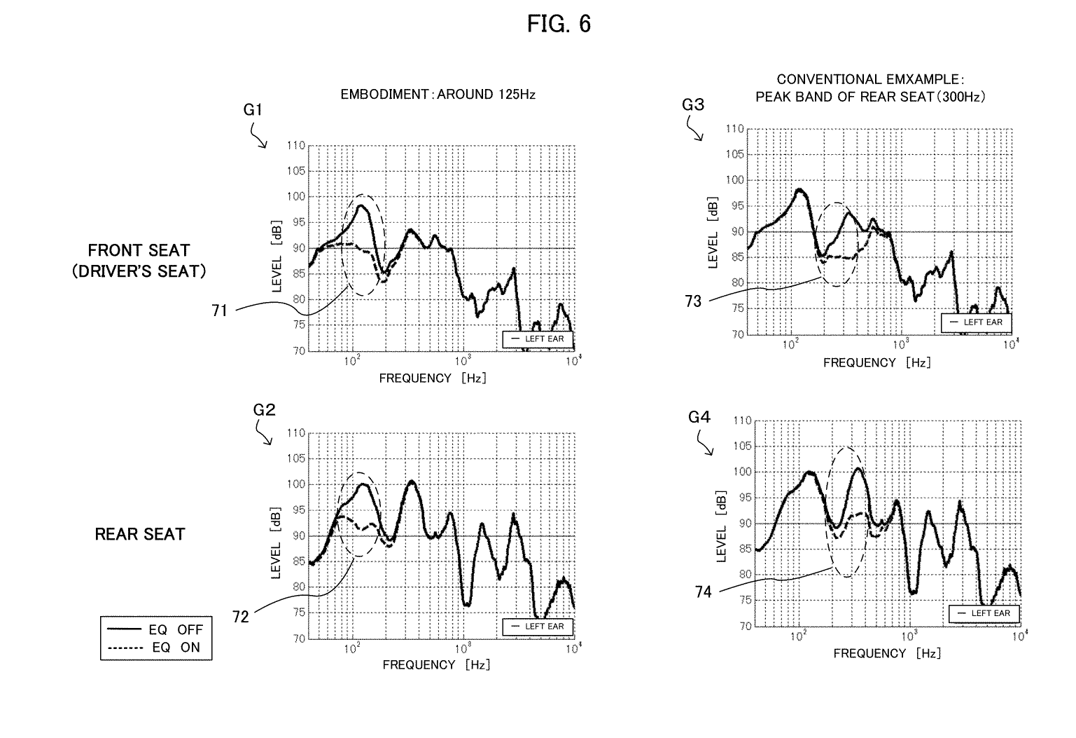

FIG. 6 illustrates graphs for comparing the embodiments in which the above-mentioned attenuation control is performed with the conventional example. The graph G1 illustrates the frequency characteristic at the front seat according to the embodiment, and the graph G2 illustrates the frequency characteristic at the rear seat according to the embodiment. The graph G3 illustrates the frequency characteristic at the front seat according to the conventional example, and the graph G4 illustrates the frequency characteristic at the rear seat according to the conventional example. It is noted that the graphs G3 and G4 of the conventional example are the graphs in a case where the frequency band of the peak frequency (approximately 300 Hz) occurring in the frequency characteristic at the rear seat is attenuated by the equalizer. In each graph, the solid line indicates the characteristic when the attenuation processing by the equalizer 12 is turned off, and the broken line indicates the characteristic when the attenuation processing by the equalizer 12 is turned on. In each graph, the listening position is the position of the left ear of the head of the passenger.

In the conventional example, as shown by the solid line in the ellipse 74 of the graph G4, the peak occurs around 300 Hz in the frequency characteristic at the rear seat. Therefore, when the equalizer for attenuating the frequency band around 300 Hz is turned on, the frequency characteristic at the rear seat becomes flat around 300 Hz as shown by the broken line in the ellipse 74. However, since there is originally no peak around 300 Hz in the front seat as shown by the solid line in the ellipse 73 of the graph G3, if the equalizer for attenuating the frequency band around 300 Hz is turned on, dip occurs around 300 Hz at the front seat as shown by the broken line in the ellipse 73, thereby deteriorating the frequency characteristic.

In contrast, according to the embodiment, as shown by the solid line in the ellipse 71 of the graph G1 and the solid line in the ellipse 72 of the graph G2, the peak occurs at both the front seat and the rear seat around 125 Hz corresponding to the common peak frequency. Therefore, when the equalizer for attenuating the frequency band around 125 Hz is turned on, the peak is alleviated at both the front seat and the rear seat as shown by the broken line in the ellipse 71 of the graph G1 and the broken line in the ellipse 72 of the graph G2, thereby improving the frequency characteristic. As described above, according to the embodiment, by attenuating the frequency band of the commonpeak frequency at which the peak occurs simultaneously at both the front seat and the rear seat, the frequency characteristics at both the front seat and the rear seat can be improved at the same time.

### Other Embodiments

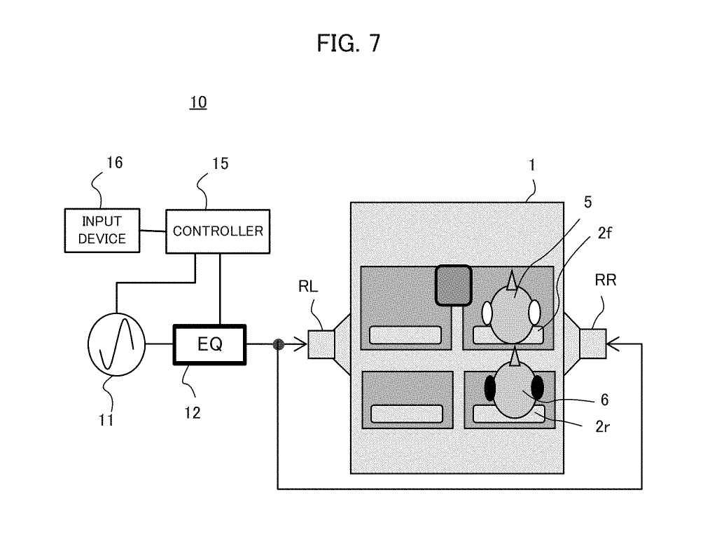

While the above-described embodiment outputs sound from only one of the rear speakers of the vehicle, the present invention is applicable to the case where both the left and right rear speakers output sounds. FIG. 7 illustrates a configuration in which the signals are inputted to the left and right rear speakers RL and RR. Specifically, the sound signal outputted by the sound source 11 is inputted to the equalizer 12, and the equalizer 12 supplies the sound signals whose level is attenuated at the controlled band to the left and right rear speakers RL and RR.

In a general vehicle interior configuration, the left and right speakers RL and RR are arranged at symmetrical positions. Accordingly, the sound outputted from the right rear speaker RR reaches the front seat 2f and the rear seat 2r as the direct sound and reaches the front seat 2f and the rear seat 2r as the reflected sound reflected by the left door. Therefore, even when the sounds are outputted by the left and right speakers RL and RR, by attenuating the sound volume level at the controlled band by a single equalizer 12, the common peak in the frequency characteristics of the front seat 2f and the rear seat 2r can be suppressed at the same time. Description will be given of the cases of the stereo signal and the monaural signal, respectively.

(In case of Stereo Signal)

In case of a stereo signal, uncorrelated signals are inputted to the left and right speakers. However, since the direct sound from the left and right rear speakers RL and RR and the reflected sound reflected by the opposite-side doors create the peak frequency at both the front and rear seats, the peak frequencies of the sound outputted by the left and right rear speakers RL and RR become the same. Therefore, by performing the attenuation control in the peak frequency band by a single equalizer, the peaks of the sounds outputted by the two rear speakers RL and RR can be suppressed at the same time.

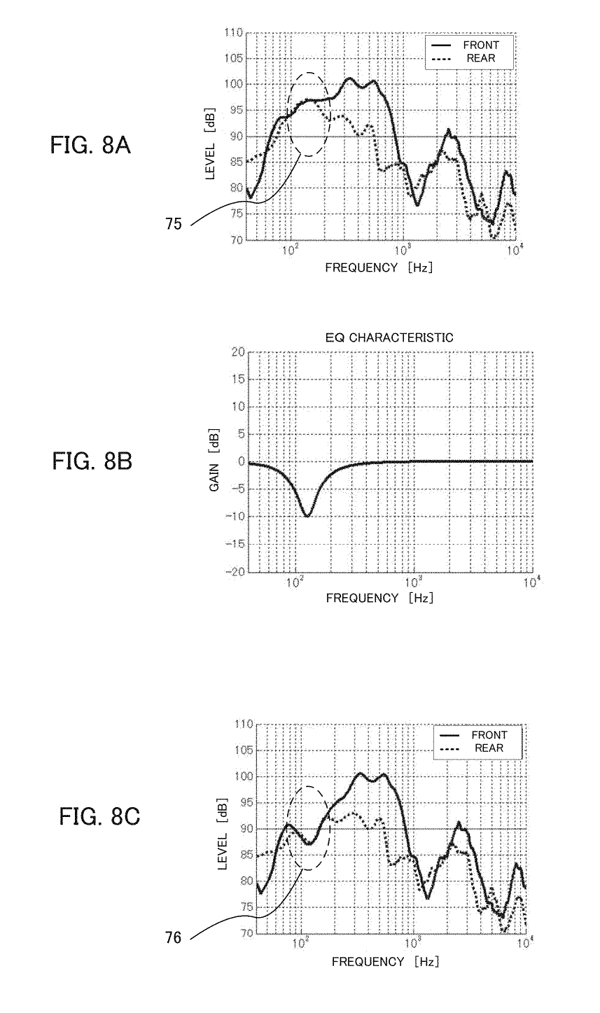

FIGS. 8A to 8C illustrate the frequency characteristics when a stereo signal is inputted to the left and right rear speakers RL and

RR in the configuration of FIG. 7. FIG. 8A illustrates the frequency characteristics at the front seat (the driver's seat) 2f and the rear seat 2f. As shown by the ellipse 75, the common peak occurs around 125 Hz. Therefore, the common peak frequency 125 Hz is determined to be the center frequency of the controlled band, and the attenuation characteristic shown in FIG. 8B is set to the equalizer 12. Thus, the frequency characteristics shown in FIG. 8C are obtained at the front seat 2f and the rear seat 2r. As shown by the ellipse 76 in FIG. 8C, the common peak around 125 Hz is suppressed.

(In Case of Monaural Signal)

In case of a monaural signal, the same signal is inputted to the left and right speakers RL and RR. Therefore, even when the monaural signal is inputted to the left and right rear speakers RL and RR, similarly to the case where the signal is inputted only one of the speakers, the peak of the sounds outputted by two rear speakers RL and RR can be suppressed at the same time by performing the attenuation control in the frequency band of the peak frequency by a single equalizer.

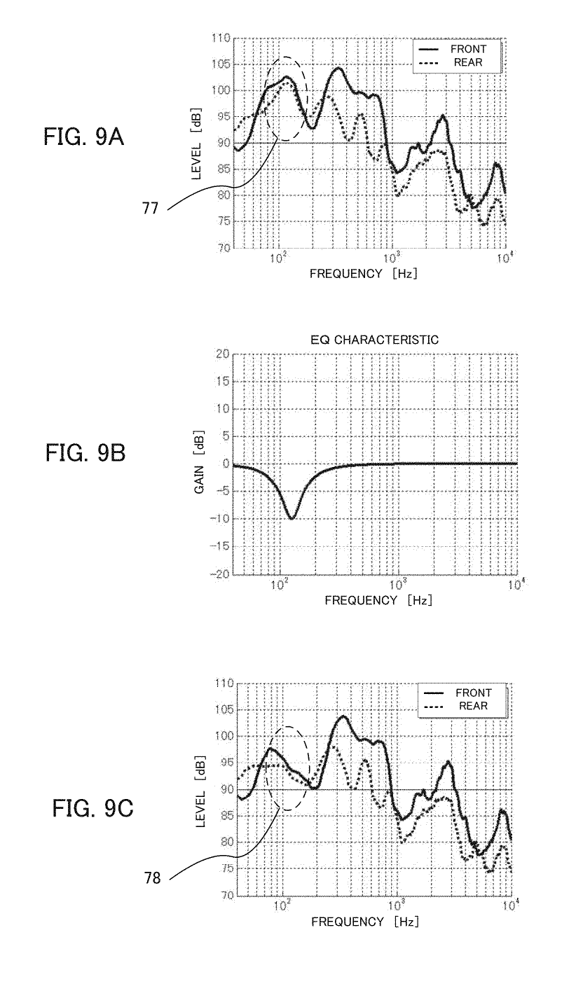

FIGS. 9A to 9C illustrate the frequency characteristics when a monaural signal, i.e., the same signal is inputted to the left and right rear speakers RL and RR in the configuration of FIG. 7. FIG. 9A illustrates the frequency characteristics at the front seat (the driver's seat) 2f and the rear seat 2f. As shown by the ellipse 77, the common peak occurs around 125 Hz. Therefore, the common peak frequency 125 Hz is determined to be the center frequency of the controlled band, and the attenuation characteristic shown in FIG. 9B is set to the equalizer 12. Thus, the frequency characteristics shown in FIG. 9C are obtained at the front seat 2f and the rear seat 2r. As shown by the ellipse 78 in FIG. 9C, the common peak around 125 Hz is suppressed.

As described above, by applying the same attenuation processing to the sound signals outputted by the left and right rear speakers RL and RR, the common peak occurring at the front and rear seats on the left side of the vehicle interior, i.e., the assistant driver's seat and its rear seat can be suppressed. As a result, it is possible to obtain the effect of suppressing the common peak for four seats in the vehicle interior at the same time.

[Attenuation Control]

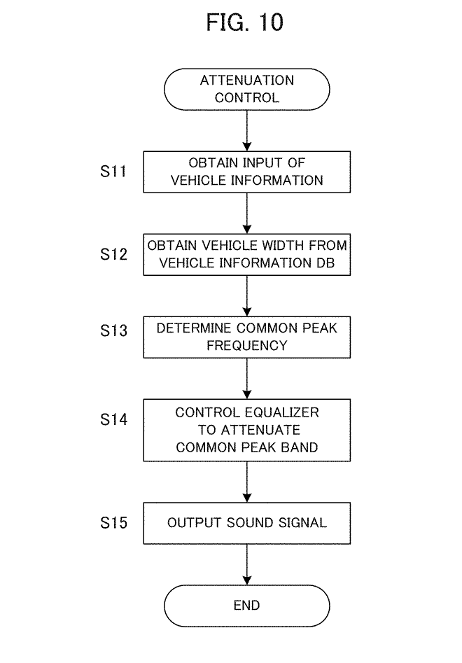

FIG. 10 is a flowchart of the attenuation control executed by the sound volume control device 10 according to the embodiment. This processing is executed mainly by the controller 15 of the sound volume control device 10. Specifically, the computer constituting the controller 15 executes this processing by executing a program prepared in advance.

First, when the user inputs the vehicle information such as the vehicle type name to the input device 16, the controller 15 obtains the inputted vehicle information (step S11), and obtains the vehicle width of the vehicle type from the vehicle information DB (step S12). Next, the controller 15 determines the common peak frequency Fpeak based on the above equation (1) (step S13), and sets the characteristic to attenuate the signal in the common peak frequency band to the equalizer 12 (step S14). Then, the controller 15 controls the sound source 11 to output the sound signal. Thus, the sound in which the common peak is suppressed is outputted by the rear speakers.

[Modified Examples]

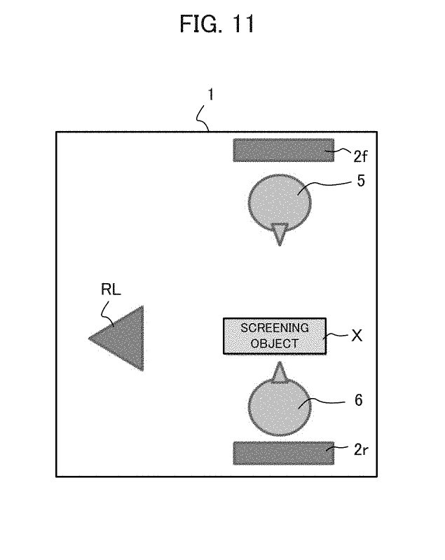

In the above embodiment, the rear speaker RL is close to the front seat and the backrest of the front seat serves as a screening object which screens the front seat space and the rear seat space from each other. Instead, the present invention is applicable to the vehicle interior environment in which the rear speaker RL is close to the rear seat and a screening object exists in the rear seat. FIG. 11 illustrates an example of a vehicle interior environment in which a screening object exists in the rear seat. In the example of FIG. 11, the rear speaker

RL is close to the rear seat. In addition, the front seat 2f is oriented to the backward of the vehicle and is confronted with the rear seat 2f. Instead of the backrest of the front seat in the above-described embodiment, there exists a screening object X between the front seat 2f and the rear seat 2r. An example of the screening object is a partition, a large screen TV or a desk. In this vehicle interior environment, the sound outputted by the rear speaker RL is partly screened by the screening object X and becomes difficult to propagate to the rear seat. In this way, the present invention is applicable to the vehicle interior environment in which the rear speaker is close to one of the front seat and the rear seat and there exists a screening object at the one of the front seat and the rear seat to which the rear speaker is close.

In the above embodiment, the equalizer 12 attenuates the signal of the common peak frequency band. In actual processing, the signal of the common peak frequency band may be attenuated and signal level of other frequency band may be maintained. Alternatively, the signal level of the common peak frequency band may be maintained and the signal level of other frequency band may be boosted so that the signal in the common peak frequency band is relatively attenuated.

As the vehicle width that the controller 15 obtains to determine the common peak frequency, i.e., the vehicle width stored in the vehicle information DB, it is optimum to use the width of the vehicle interior. However, if it is difficult to obtain the width of the vehicle interior, the width of the vehicle exterior described in a catalog of the vehicle may be used instead. Alternatively, the value obtained by subtracting the thickness of a general door from the width of the vehicle exterior may be stored in the vehicle information DB.

In the above embodiment, the vehicle information DB is prepared in the controller 15 installed in the vehicle. Instead, the vehicle information DB may be prepared in a server and the controller 15 installed in the vehicle may obtain the vehicle width from the server by communication. Specifically, the controller 15 may transmit the vehicle information such as the vehicle type name inputted to the input device 16 to the server, and may receive the width of the vehicle type from the server to use.

### INDUSTRIAL APPLICABILITY

This invention can be used for a sound reproduction device loaded on a vehicle.

### BRIEF DESCRIPTION OF REFERENCE NUMBERS

1 Vehicle

2f Front seat (Driver's seat)

2f Rear seat

10 Sound volume control device

11 Sound source

12 Equalizer

15 Controller

16 Input device

1. A sound volume control device connected to an output unit arranged between a front seat and a rear seat of a movable body, comprising:
an estimating unit configured to estimate a frequency of a peak, common to frequency characteristics at the front seat and the rear seat, of sound outputted by the output unit; and
a correcting unit configured to correct a level of the sound outputted by the output unit at the frequency of the peak.

2. The sound volume control device according to claim 1, wherein the peak is generated by synthesizing a direct sound and a reflected sound, the direct sound being a sound outputted by the output unit and reaching a listening position without being reflected in the movable body, the reflected sound being a sound outputted by the output unit and reaching the listening position after being reflected by a predetermined position in the movable body.

3. The sound volume control device according to claim 1, wherein the estimating unit estimates the frequency of the peak based on vehicle information of the movable body.

4. The sound volume control device according to claim 3, further comprising an input device configured to input the vehicle information of the movable body,
wherein the estimating unit estimates the frequency of the peak based on the vehicle information inputted.

5. The sound volume control device according to claim 1, wherein the estimating unit estimates the frequency of the peak by an equation based on a vehicle width of the movable body.

6. The sound volume control device according to claim 1, wherein the output unit is arranged at a position close to one of the front seat and a rear seat.

7. The sound volume control device according to claim 1,
wherein one of the front seat and the rear seat includes a screening object, and
wherein the screening object partly screens the sound outputted by the output unit and reaching a listening position in the one of the front seat and the rear seat that includes the screening object.

8. A sound volume control method executed by a sound volume control device connected to an output unit arranged between a front seat and a rear seat of a movable body, comprising:
an estimating process configured to estimate a frequency of a peak, common to frequency characteristics at the front seat and the rear seat, of sound outputted by the output unit; and
a correcting process configured to correct a level of the sound outputted by the output unit at the frequency of the peak.

9. A non-transitory computer-readable medium storing a program executed by a sound volume control device including a computer and connected to an output unit arranged between a front seat and a rear seat of a movable body, the program causing the computer to function as:
an estimating unit configured to estimate a frequency of a peak, common to frequency characteristics at the front seat and the rear seat, of sound outputted by the output unit; and
a correcting unit configured to correct a level of the sound outputted by the output unit at the frequency of the peak.

10. (canceled)
